(19) United States
(12) Patent Application Publication
(10) Pub. No.: US 2013/0082973 A1
(43) Pub. Date: Apr. 4, 2013

(54) DISPLAY DEFORMATION DETECTION

(71) Applicants: Joshua Grey Wurzel, Sunnyvale, CA (US); Ahmad Al-Dahle, Santa Clara, CA (US); Yafei Bi, Palo Alto, CA (US)

(72) Inventors: Joshua Grey Wurzel, Sunnyvale, CA (US); Ahmad Al-Dahle, Santa Clara, CA (US); Yafei Bi, Palo Alto, CA (US)

(73) Assignee: APPLE INC., Cupertino, CA (US)

(21) Appl. No.: 13/251,113

(22) Filed: Sep. 30, 2011

(51) Int. Cl. G06F 3/044; G06F 3/045

(52) U.S. Cl. 345/174

(57) ABSTRACT

Disclosed embodiments relate to a display deformation detection system that detects display deformations based upon changes in resistance and/or capacitance. In one embodiment, a method includes measuring a baseline comprising a baseline resistance or a baseline capacitance or both of a conductive mesh disposed within or overlaid on the display panel. The method further includes detecting a change in the baseline resistance or the baseline capacitance or both and calculating a change location where the change in the baseline resistance or the baseline capacitance or both occurred. The method also includes calculating a magnitude of the change in the baseline resistance or the baseline capacitance or both.

### BACKGROUND

The present disclosure relates generally to display panels, and more particularly, to deformation detection in such display panels.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Many electronic devices include display panels that provide visual images to a user of the electronic device. These display panels may be susceptible to damage when unintended pressure is applied to the display panels. Some pressure may be internal, deriving from internal components behind the display. Other pressure may be external, occurring when a user inadvertently applies excessive pressure to the display.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Embodiments of the present disclosure relate to devices and methods for detecting deformations (e.g., geometrical changes due to exerted pressure) of a display panel of an electronic device. In certain embodiments, the display panel deformations may be useful to detect and diagnosis unintended pressure exerted on the display panel. Further, in certain embodiments, the display panel deformations may be useful in detecting intentional pressure exerted on the display panel.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. Again, the brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a schematic block diagram of an electronic device with display panel deformation detection system, in accordance with an embodiment;

FIG. 2 is a perspective view of a handheld electronic device including the display panel deformation detection system, in accordance with an embodiment;

FIG. 3 is a schematic view of a display deformation detection system, including a conductive mesh, in accordance with an embodiment;

FIG. 4 is a schematic representation of a display panel with a concave deformation, in accordance with an embodiment;

FIG. 5 is a schematic representation of a display panel with a convex deformation, in accordance with an embodiment; and

FIG. 6 is a flow chart depicting a process for detecting display panel deformations, in accordance with an embodiment.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

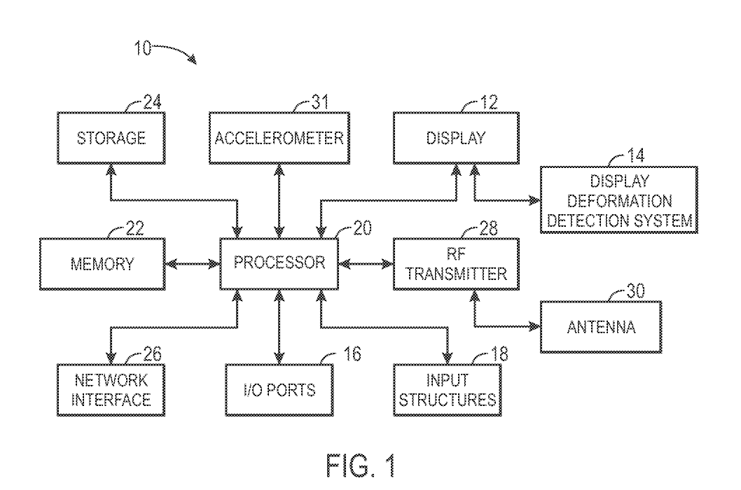

As may be appreciated, electronic devices may include various components that contribute to the function of the device. For instance, FIG. 1 is a block diagram illustrating components that may be present in one such electronic device 10. The various functional blocks shown in FIG. 1 may include hardware elements (including circuitry), software elements (including computer code stored on a computer-readable medium, such as a hard drive or system memory), or a combination of both hardware and software elements. FIG. 1 is only one example of a particular implementation and is merely intended to illustrate the types of components that may be present in the electronic device 10. For example, in the presently illustrated embodiment, these components may include a display 12, a display deformation detection system 14, input/output (I/O) ports 16, input structures 18, one or more processors 20, one or more memory devices 22, non-volatile storage 24, a network interface 26, an RF transmitter 28, an antenna 30 coupled to the RF transmitter 28, and an accelerometer 31.

The network interface 26 may provide communications capabilities through a wired (e.g., Ethernet) or wireless (e.g., Wi-Fi) network. Further, the RF transmitter 28 may provide communications through radio frequency signals. The accelerometer 31 may measure an acceleration of the electronic device 10 and provide the measured acceleration to the processor 20.

The display 12 may be used to display various images generated by the electronic device 10. For example, the processor 20 may provide image data to the display 12. Further, the non-volatile storage 24 may be configured to store image data provided by the processor 20. The display 12 may be any suitable liquid crystal display (LCD), such as a fringe-field switching (FFS) and/or an in-plane switching (IPS) LCD. Additionally, the display 12 may have touch-sensing capabilities that may be used as part of the control interface for the electronic device 10.

The display 12 may be coupled to the display deformation detection system 14, controlled by the processor 20. As will be described in more detail below, the display deformation detection system 14 may enable the processor 20 to detect geometrical changes in the display 12. Information about these geometrical changes or deformations may be stored in the non-volatile storage 24 or communicated to an external entity (e.g., through use of the I/O ports 16, the network interface 26, or the RF transmitter 28).

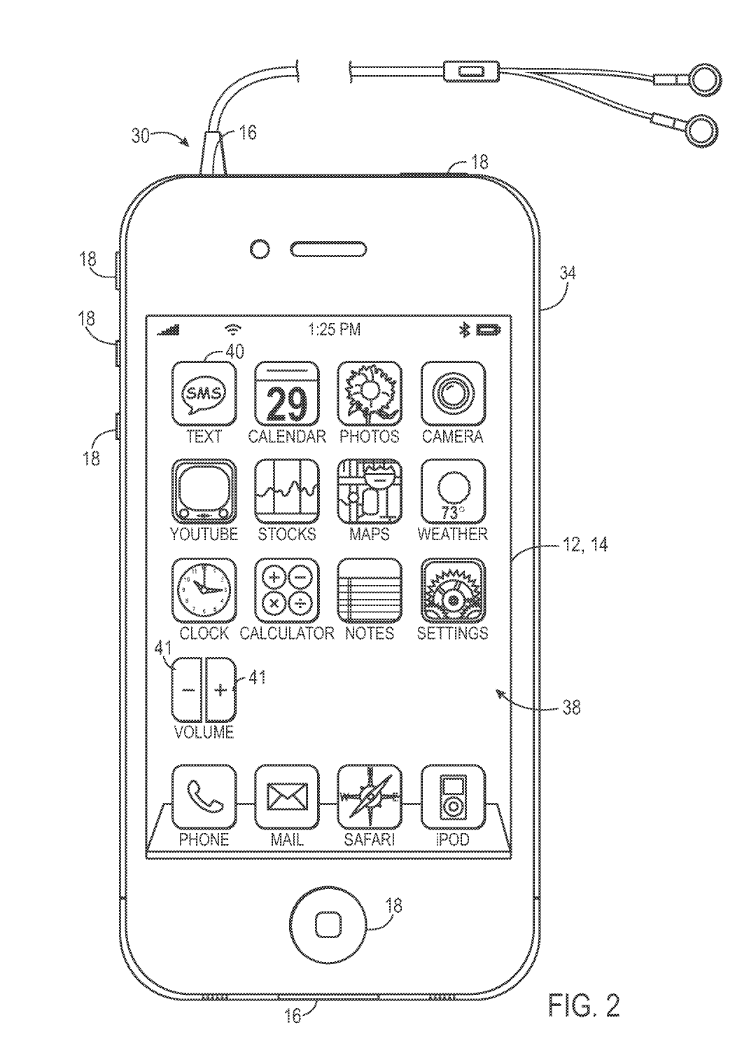

The electronic device 10 may take the form of a cellular telephone or some other type of electronic device. In certain embodiments, electronic device 10 in the form of a handheld electronic device may include a model of an iPod® or iPhone® available from Apple Inc. of Cupertino, Calif. By way of example, an electronic device 10 in the form of a handheld electronic device 30 (e.g., a cellular telephone) is illustrated in FIG. 2 in accordance with one embodiment. The depicted handheld electronic device 30 includes a display 12 (e.g., in the form of an LCD or some other suitable display), I/O ports 16, and input structures 18.

Although the electronic device 10 is generally depicted in the context of a cellular phone in FIG. 2, an electronic device 10 may also take the form of other types of electronic devices. In some embodiments, various electronic devices 10 may include media players, personal data organizers, handheld game platforms, cameras, and combinations of such devices. For instance, the electronic device 10 may be provided in the form of handheld electronic device 30 that includes various functionalities (such as the ability to take pictures, make telephone calls, access the Internet, communicate via email, record audio and video, listen to music, play games, and connect to wireless networks). In another example, the electronic device 10 may also be provided in the form of a portable multi-function tablet computing device. By way of example, the tablet computing device may be a model of an iPad® tablet computer, available from Apple Inc. Alternatively, the electronic device 10 may also be provided in the form of a desktop or notebook computer with the display 12. For example, the desktop or notebook computer may be a model of an iMac®, MacBook Air®, or MacBook Pro® equipped with a display 12. Although the following disclosure uses the handheld device 30 by way of example, it should be understood that the display deformation detection system 14 may be employed in like fashion in any suitable form factor, such as those mentioned above.

In the depicted embodiment, the handheld electronic device 30 includes the display 12 with the display deformation detection system 14 of FIG. 1. The display 12 may display various images generated by the handheld electronic device 30, such as a graphical user interface (GUI) 38 having icons 40. A user may interact with the handheld device 30 by accessing the user inputs 18 and accessing the GUI 38 through touching the display 12. In certain embodiments, the display deformation detection system 14 may aid in the user interaction with the GUI 38 of the handheld electronic device 30. For example, when a user exerts an intended force upon the display 12, a deformation may occur in the display 12. The display deformation detection system 14 may detect the location of the deformation and provide a user input signal to the processor 20 based upon the deformation location. For example, the user may desire to send an SMS text message via the handheld electronic device 30. The user may press the display 12 over the SMS text message icon 40 to open the SMS text messaging application. Upon pressing the display 12, a display 12 deformation may occur. As will be discussed in more detail below, the display deformation detection system 14 may determine a location of the deformation and provide the location to the processor 20. The processor 20 may interpret the location provided by the display deformation detection system 14 as a user input over the SMS text message icon 40 and thus execute the SMS text messaging application.

In certain embodiments, as will be described in more detail below, the display deformation detection system 14 may provide a magnitude of the display deformation. The provided deformation magnitude may also aid in the user interaction with the GUI 38 of the handheld electronic device 30. In certain embodiments, the GUI 38 may be enabled to provide a variety of functionalities based upon an amount of force provided to the GUI 38. In one embodiment, an icon may be enabled to affect a change at different rates based upon a pressure exerted on the icon. For example, in the depicted embodiment, the volume icons 41 may be enabled to increase or decrease a volume of the handheld electronic device 30 in 1 dB increments when a light force is provided to the volume icons 41. When a heavy force is applied to the icons 41, the volume may be increased or decreased at a higher increment (e.g., 5 dB). In some embodiments, the display deformation detection system 14 may be enabled to provide levels (e.g., low, medium, and high) of force to the processor 20 or other data processing circuitry based upon the magnitude of deformation of the display 12 breaching certain thresholds. In other embodiments, the display deformation detection system 14 may provide a continuously variable amount of force based upon the actual deformation magnitude.

The deformation detection system 14 may also be useful in diagnosing damage of the display 12. Damage to display 12 of the handheld electronic device may occur when excessive force is applied to the display 12. For instance, when the handheld electronic device 30 is dropped, the display 12 may break due to the impact from the drop. Further, when the display 12 uses in-plane switching technology, light leakage may occur when a display 12 is deformed. The display deformation detection system 14 may provide a clear understanding of geometrical changes that occur in a display 12 and pressures exerted on the display 12, which may enable diagnosis of the details surrounding the display 12 damage. For example, the display deformation detection system 14 may be enabled to store display deformation information when a magnitude of force breaches an excessive force threshold. In some embodiments, the excessive force threshold may be approximately 100 newtons. Upon detecting a magnitude of force that meets or exceeds the excessive force threshold, the display deformation detection system 14 may be enabled to store deformation statistics, such as the time of the deformation, the deformation location, and/or the deformation magnitude. In some embodiments, the display deformation detection system 14 may derive and store a deformation gradient map (e.g., a snapshot of all deformations and their associated statistics) at the time the excessive force threshold is met. The deformation gradient map may provide a clearer understanding of the cause of the excessive pressure exertion by detailing each of the deformations that occurred at the time of the excessive pressure exertion.

Manufacturers of the handheld electronic device 30 may also use the display deformation detection system 14 to diagnose potential display 12 damage during the design process of the handheld electronic device 30. For example, before being released to the public, the handheld electronic device 30 may be subjected to a multitude of testing, such as human factors testing. Human factors testing involves understanding a human's interaction with a device to create a better design. The display deformation detection system 14 may improve human factors testing during the design process by providing new measurements of display strain caused by human interaction with the device. For example, a human factors study may show that users of the handheld electronic device 30 typically place the handheld electronic device 30 in their pants pocket, when not in use. The display deformation detection system 14 may provide measurements of display deformations caused by this activity, thus allowing the manufacturer to modify the design based upon the display deformations caused by storing the handheld electronic device 30 in the user's pocket.

In one example, the display deformation detection system 14 may detect a convex deformation (as depicted in FIG. 5), suggesting that the display is being bent outward. The handheld electronic device 30 manufacturers may determine that such a deformation is possible because the chassis of the handheld electronic device 30 is only semi-rigid, allowing the electronic handheld device 30 to bend more than it should. Based upon data provided through the display deformation detection system 30, the manufacturer may be able to incorporate a more rigid chassis prior to releasing the handheld electronic device 30 to the public.

In certain situations a manufacturer may desire to enable the display deformation detection system 14 when a drop is likely occurring. Such selective enablement may preserve battery life of the handheld electronic device when the display deformation detection system 14 is merely used to diagnose causes of display 12 damage. In such embodiments, the accelerometer 31 of FIG. 1 may be used to activate the display deformation detection system 14. The accelerometer 31 may measure the acceleration of the handheld electronic device 30 and provide the measured acceleration to the processor 20. The processor 20 may detect a likely drop or other abrupt movement of the handheld electronic device 31 (e.g., through detecting a measured acceleration that meets or exceeds an excessive acceleration threshold). Based upon detecting the likely drop or other abrupt movement, the processor 20 may activate the display deformation detection system 14. The display deformation detection system 14 may then detect display deformations and provide results to the processor 20. After a period of use, the processor 20 may deactivate the display deformation detection system 14.

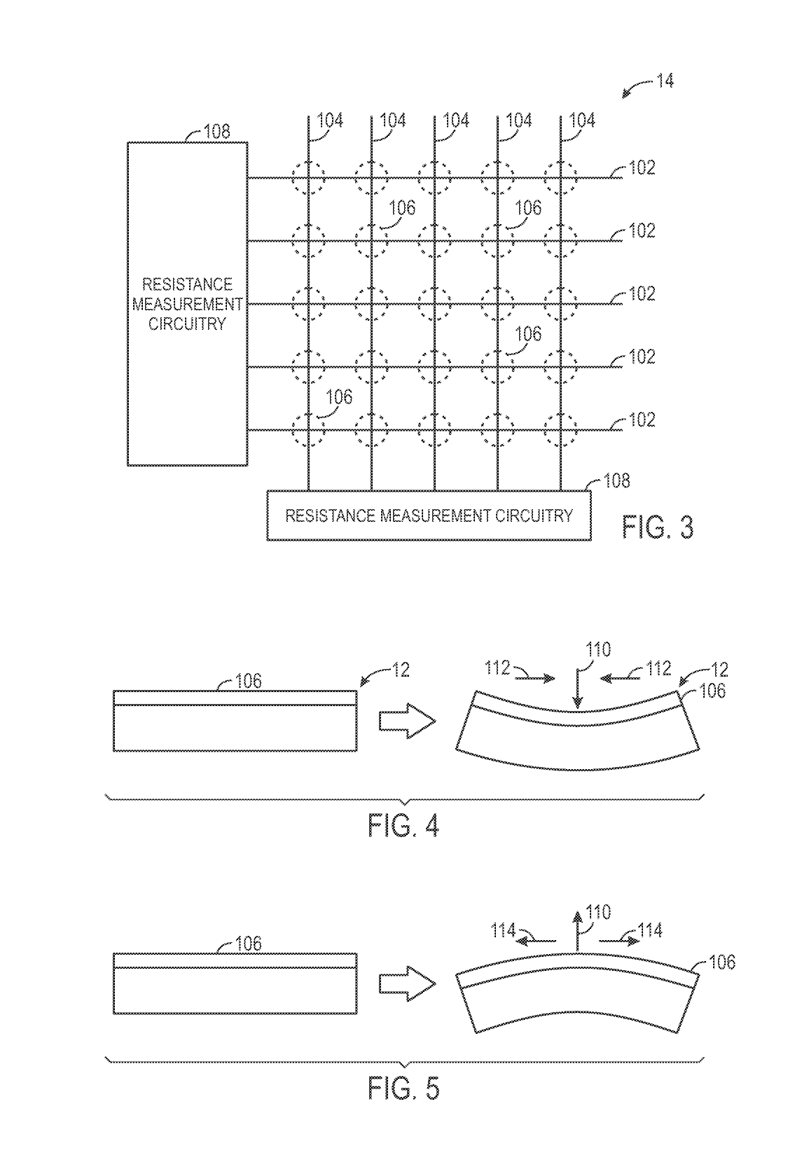

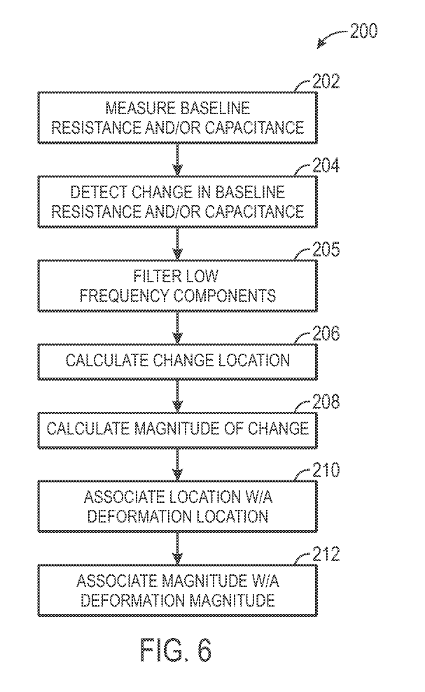

Turning now to a more detailed description of how the display deformation detection system may be implemented, FIG. 3 illustrates an embodiment of a display deformation detection system 14 using a mesh layer 100. FIGS. 4 and 5 illustrate display deformation examples and FIG. 6 provides a process for detecting the display 12 deformations. For clarity, FIGS. 3-6 will be discussed jointly. The mesh layer 100 disposed within or overlaid on the display 12. The mesh layer 100 may be may include an array of rows 102 and columns 104 of crossing wires. The rows 102 and columns 104 may be disposed on separate planes, such that they only touch at crossing points when a force is applied to the rows 102 and/or columns 104. In some embodiments, the wires may consist of Indium Tin Oxide (ITO). The resolution of the mesh layer 100 may be very fine (e.g., each wire may be very thin and close to the other wires). For example, the wires may have a diameter of approximately 10 microns and/or may be spaced within 70 microns of each other. As the wires of the mesh layer 100 (e.g., rows 102 and columns 104) stretch or compress, the resistance and/or capacitance of wires change. Thus, the resistance and/or capacitance of the resistance pixels 106 (e.g., areas where the wires cross) may also change. For example, as a force 110 is applied to the display 12, some wires of the mesh layer 100 may stretch and some wires of mesh layer 100 may compress. To detect display deformations, resistance and/or capacitance changes in the mesh layer 100 may be measured. To do this, baseline resistance and/or capacitance measurements may be obtained (block 202). For example, the rows 102 and columns 104 may be coupled to resistance and/or capacitance measurement circuitry 108. The resistance and/or capacitance measurement circuitry 108 may measure a baseline resistance and/or capacitance at portions of the wire mesh layer 100 where the rows 102 and columns 104 intersect (e.g., the resistance pixels 106). In other embodiments, the resistance and/or capacitance measurement circuitry may be coupled to common voltage wires of the display 12 to determine the baseline resistance and/or capacitance measurements. The common voltage wires supply a common voltage to a common electrode of the display 12.

When a force 110 is exerted on the display 12, the resistance and/or capacitance of the wires will change. For example, as illustrated in FIG. 4, a downward force 110 is exerted on the display 12. The downward force 110 may cause the wires to compress 112 at one or more resistance pixels 106. As the wires compress 112, the resistance may decrease (and thus the capacitance may increase). Further, as illustrated in FIG. 5, an upward force 110 may be exerted on the display panel (e.g., from underlying components of the handheld electronic device 30), causing the wires to stretch 114 at one or more resistance pixels 106 near the exerted force 110. As the wires stretch, the resistance may increase (and thus the capacitance may decrease). The resistance and/or capacitance measurement circuitry 108 may periodically or continuously measure the resistance and/or capacitance of the mesh layer 100 at the resistance pixels 106. The processor 20 via a driver or instructions for the processor 20 may detect the change in resistance and/or capacitance based upon the measurements by the resistance and/or capacitance measurement circuitry 108 (block 204). As discussed above, in certain embodiments, the display deformation detection system 14 may poll for new resistance and/or capacitance measurements when an accelerometer measurement provides an indication that the handheld electronic device 10 is being dropped.

In certain embodiments, the display deformation measurements may be associated with resistance and/or capacitance values that transition rapidly compared to other stimuli that may affect the resistance and/or capacitance (e.g., temperature changes). For example, the display deformations may cause resistance and/or capacitance values in the wire mesh 100 to shift rapidly, due to the deformations occurring rapidly. Thus, slowly transitioning variations in resistance and/or capacitance (e.g., those caused by temperature changes) may be filtered with a low frequency filter (e.g., a high pass filter) (block 205). The resistance and/or capacitance measurement circuitry 108 may then provide the filtered resistance and/or capacitance measurements to the processor 20 or other data processing circuitry.

Upon finding a change in the baseline resistance and/or capacitance, the display deformation detection system 14 may determine a location (e.g., locations of the resistance pixels 106) where the change occurred (block 206). Further, the measure of the change in the resistance and/or capacitance from the baseline may be measured by the resistance and/or capacitance measurement circuitry 108 to calculate a magnitude of change (block 208).

As previously discussed, the rows 102 and columns 104 of wires may be very small. Thus, the wires may include a very low resistance. Therefore, the change in resistance and/or capacitance based upon the deformation may also be quite low. The resistance and/or capacitance measurement circuitry 108 may include very sensitive measurement circuitry to account for the very low resistance levels. In certain embodiments, the change in resistance of the wires may be on the order of micro-ohms.

Certain processor instructions executed on the electronic device may utilize information relating to the deformation location and/or deformation magnitude rather than a resistance and/or capacitance change location and magnitude. Thus, in some embodiments, it may be beneficial to associate the location of the resistance and/or capacitance change with a display deformation location (e.g., the location of the resistance pixels 106 where the change occurred) (block 210) and associate the magnitude of change in the resistance and/or capacitance with a magnitude of the deformation of the display 12 or a magnitude of force exerted upon the display 12 (block 212). In certain embodiments, a lookup table stored in the non-volatile storage 24 may associate magnitude of force values with specific resistance change values. Using the lookup table, the processor 20 may associate the resistance and/or capacitance change with a magnitude of force exerted on the handheld electronic device 30.

As previously discussed, the deformation statistics (e.g., the deformation location, the deformation magnitude, and/or the deformation time) may be stored in the non-volatile storage 24 for later retrieval. The deformation statistics may be retrieved via the network interface 26, the RF transmitter 28 and/or the I/O ports 16. Once retrieved, the stored deformation statistics may be removed from the non-volatile storage 24. In certain embodiments, periodically, the stored deformation statistics may be removed to provide more storage space in the non-volatile storage 24.

In certain embodiments, it may be desirable to reset (e.g., re-measure) the baseline periodically. Over time, the mesh layer 100 may retain some of the capacitance and/or resistance changes caused by display 12 deformations. Resetting the baseline may help to ensure that any retained capacitance and/or resistance changes are taken into account when determining the changes in resistance and/or capacitance of the wires. The baseline may be measured at pre-determined time periods or upon the occurrence of certain events. For example, the baseline might be re-measured daily at midnight or once per month at 3:00 A.M. In other embodiments, the baseline may be reset by through at a manufacturer's facility when the handheld electronic device 30 is brought in for repair. In cellular telephone embodiments, the baseline may be reset automatically each time a new cellular service tower is encountered by the cellular telephone. Further, the baseline may be reset through the use of a menu setting displayed on the GUI 38.

Measuring and reporting display deformation locations and magnitudes may be useful in detecting both intentional and unintentional display panel strain caused by force applied the display 12. For example, intentional display panel strain may be useful in providing a more dynamic GUI 38 that takes into account an amount of force that is being applied via touch input to the display 12. Further, unintentional display panel strain may be measured during the design process to understand the strains that will be encountered by the display 12 by human factors. Additionally, the display panel strain may be useful in diagnosing damage to the display 12, by recording forces applied to the display 12 before or during the time when the damage occurred.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A method of detecting a deformation in a display panel, comprising:
detecting a change in a baseline resistance or a baseline capacitance or both of a conductive mesh disposed within or overlaid on the display panel;
calculating a change location where the change in the baseline resistance or the baseline capacitance, or both, occurred; and
calculating a magnitude of the change in the baseline resistance or the baseline capacitance, or both.

2. The method of claim 1, comprising filtering low frequency changes in the baseline resistance or the baseline capacitance, or both, via a high pass filter.

3. The method of claim 1, comprising:
detecting movement of the display panel via an accelerometer; and
detecting the change in the baseline resistance or the baseline capacitance, or both, upon detecting the movement of the display panel.

4. The method of claim 1, comprising associating the deformation magnitude with a drop of the display panel.

5. The method of claim 1, comprising determining a touch command based at least in part upon the deformation.

6. The method of claim 5, wherein the touch command includes both a location of the touch command associated with the change location and a force of the touch command associated with the magnitude of change.

7. The method of claim 1, comprising monitoring the deformation of the display panel during the design process of the display panel.

8. The method of claim 1, associating the change location with a deformation location.

9. The method of claim 1, comprising associating the magnitude of the change with a deformation magnitude.

10. The method of claim 1, comprising measuring the baseline resistance or the baseline capacitance, or both.

11. A display deformation detection system, comprising:
a display configured to provide a graphical image;
a conductive mesh disposed on or in the display, having a baseline resistance and a baseline capacitance; and
deformation detection circuitry, configured to:
determine the baseline resistance or the baseline capacitance, or both, of the conductive mesh;
detect a change in baseline resistance or the baseline capacitance, or both, in at least one portion of the conductive mesh;
store change information relating to the change in baseline resistance or the baseline capacitance, or both; and
associate the change information with a deformation in the display.

12. The display deformation detection system of claim 11, wherein the deformation detection circuitry is configured to detect a change in the baseline resistance of an order of micro-ohms.

13. The display deformation detection system of claim 11, wherein the deformation detection circuitry is configured to detect a change in the baseline capacitance of an order of micro-ohms.

14. The display deformation detection system of claim 11, wherein the deformation detection circuitry is configured to:
store a location and a magnitude of the change in resistance or the change in capacitance, or both;
calculate a deformation location based upon the location of the change in the baseline resistance or the change in the baseline capacitance, or both; and
calculate a deformation magnitude based upon the magnitude of the change in the baseline resistance or the change in the baseline capacitance or both.

15. The display deformation detection system of claim 11, wherein the conductive mesh comprises a common voltage layer of the display panel, the common voltage layer configured to supply a common voltage to a common electrode of the display panel.

16. The display deformation detection system of claim 11, comprising an accelerometer configured to detect a drop of the display panel, wherein the display deformation detection circuitry is configured to detect the change in the baseline resistance or the baseline capacitance or both when the drop is detected.

17. The display deformation detection system of claim 11, wherein the display deformation detection circuitry is configured to detect the change in the baseline resistance or the baseline capacitance or both at periodic polling increments.

18. The display deformation detection system of claim 11, wherein the display deformation detection circuitry is configured to remove the stored location and the stored magnitude of the change in the baseline resistance or the baseline capacitance or both at periodic intervals.

19. The display deformation detection system of claim 11, wherein the display deformation detection circuitry is configured to determine the baseline resistance or the baseline capacitance or both at periodic intervals.

20. The display deformation detection system of claim 11, wherein the display deformation detection circuitry is configured to re-determine the baseline resistance or the baseline capacitance or both as the display deformation detection system passes a cellular tower.

21. An electronic device, comprising:
a display configured to provide a graphical user interface of the electronic device;
a conductive mesh disposed in or on the display, having a baseline resistance or a baseline capacitance or both; and
a processor configured to:
detect a variation from the baseline resistance or the baseline capacitance or both;
associate a location of the variation from the baseline resistance or the baseline capacitance or both with a deformation location;
associate a magnitude of the variation from the baseline resistance or the baseline capacitance or both with a deformation magnitude; and
provide a graphical user interface input instruction based upon the deformation location or the deformation magnitude or both.

22. The electronic device of claim 21, wherein the processor is configured to detect the variations from the baseline resistance or capacitance or both at periodic intervals.

23. The electronic device of claim 21, wherein the processor is configured to provide the graphical user interface instruction, wherein the graphical user interface instruction includes the deformation location and the deformation magnitude.

24. The electronic device of claim 23, wherein the graphical user interface is configured to respond differently based upon variations in the deformation magnitude.
